(19) United States
(12) Patent Application Publication
(10) Pub. No.: US 2024/0189638 A1
(43) Pub. Date: Jun. 13, 2024

(54) FIRE SUPPRESSION SYSTEM

(71) Applicant: Zenova Ltd, Brentwood, Essex (GB)

(72) Inventor: Graeme SARGENT, Brentwood (GB)

(21) Appl. No.: 18/286,079

(22) PCT Filed: Apr. 7, 2022
(86) PCT No.: PCT/GB2022/050884

§ 371 Date: Oct. 6, 2023

(30) Foreign Application Priority Data
Apr. 8, 2021 (GB) 2105006.7
Sep. 3, 2021 (GB) 2112594.3

(51) Int. Cl. A62C 35/68; A62C 35/13

(52) U.S. Cl. CPC A62C 35/68; A62C 35/13

(57) ABSTRACT

A fire suppression system is disclosed. The system comprises a housing having one or more ports to receive a nozzle of a fire extinguisher. The fire extinguisher itself includes a container to house a fire-extinguishing fluid, the container being fluidly linked with the nozzle. Actuation of the nozzle allows fire-extinguishing fluid to exit the container via the nozzle, whereby insertion of a nozzle into a port actuates the nozzle. The or each port is in fluid linkage with a distribution head by means of a pipe to distribute fire extinguishing fluid, the port and the distribution head being fluidly linked.

### FIELD OF THE INVENTION

The present invention relates to an improvement to a fire suppression system, which is particular suitable for many commercial buildings. The system provides an improved means of enabling greater volumes of a fire-suppression fluid to be stored and selectively distributed.

### BACKGROUND TO THE INVENTION

Fire-extinguishing equipment frequently uses an extinguishing medium such as foam, water or powder to extinguish a fire. Such materials are stored in a tank prior to use. A common method for getting the extinguishing medium out of the tank is to pressurise the contents of the vessel in which the medium is stored so that when the vessel is opened, in use, the increased pressure inside the tank drives the medium out of a nozzle.

In many residential housing units or blocks, major problems exist with residential automated fire suppression systems such as sprinkler systems. Conventional ceiling-mounted fire suppression systems use sprinklers connected to a water tank via pipes. There are many disadvantages to such systems including the following:—
(a) cost of installation, even when retrofit for example to an existing block of flats.
(b) Retrofitting is both time-consuming and hugely inconvenient to tenants as the installation of hundreds of meters of piping causes significant disruption, disturbance, dust and noise.
(c) Such systems are either gravity fed which requires a substantial water tank to be located on a roof top (which is not always possible due to weight and/or space restrictions on roof tops) or requires a substantial ground-based water tank together with a diesel engine to pump the water and additional piping—a solution which requires both space and regular maintenance of the diesel engine.
(d) The water in such systems needs to be regularly drained and tested for e.g. Legionnaires' disease.
(e) When used, such systems cause a significant amount of water related damage not just to the apartment where they are located but also in particular to properties situated below them.
(f) Such systems are prone to wide scale accidental triggering. Deliberate triggering is also sadly all too common by disgruntled tenants for their own financial gain.
(g) Such systems cannot be deployed in kitchens, which is where the majority of residential fires start.

The high costs associated with plumbing, pumping, and water supply make them out of reach for many applications unless mandated, meaning only a small segment of the population is protected. Oftentimes water sprinkler systems are next to impossible to install in retrofit scenarios, and so the current sprinkler industry focuses primarily on new builds.

Water puts out fires mainly because it has a very high latent heat of vaporisation (approximately 2,260 kJ/kg) so that during the phase change from water to steam, heat energy is removed from the combusting material until a point is reached at which the temperature of the combusting material drops below the combustion point and the fire goes out. However, very hot and or large fires require enormous amounts of water to cool them sufficiently so as to extinguish them. To deliver the required volume of water can take a very long time: Grenfell Tower was still burning more than sixty hours after the fire started. The sheer volume of water that is needed to extinguish a fire often means that sprinkler systems cause much more damage than the fire which triggered them.

The present invention seeks to provide a solution to the above problems by providing an improved fire suppression system, and includes in one aspect of the invention a means for housing multiple vessels.

### SUMMARY OF THE INVENTION

According to the invention there is provided a fire suppression system, the system comprising a housing having one or more ports to receive a nozzle of a fire extinguisher, the fire extinguisher including a container to house a fire-extinguishing fluid, the container being fluidly linked with the nozzle, actuation of the nozzle allowing fire-extinguishing fluid to exit the container via the nozzle, insertion of a nozzle into a port actuating the nozzle, the or each port being in fluid linkage with a distribution head by a pipe to distribute fire extinguishing fluid, the port and the distribution head being fluidly linked.

Preferably, the distribution head is selected from a misting sprinkler head, an aspirating head, regular sprinkler head or the like to provide the required distribution pattern for the extinguishing medium.

Preferably, the port includes a connection to receive a nozzle. Alternatively preferably or additionally, the pipe includes a one-way valve to prevent fluid flowing in an undesired direction.

Optionally, the system includes a pressure gauge to determine the pressure in a pipe allowing the pressure within a vessel to be monitored.

Preferably, the system includes a plurality of vessels, in which, further optionally, different vessels contain different fire-extinguishing fluids to allow different types of fire to be extinguished from a single housing.

A vessel is preferably supported by a bracket support including a profiled section within which the vessel is seated. Said profiled section is further preferably coated or covered by a material having a high co-efficient of friction to resist rotation of the vessel. Yet further preferably or additionally preferably, the bracket supports includes means such as a lug to resist vessel rotation.

Preferably the housing includes a compression bracket having an end-plate mounted to the housing by a spring-loaded mount to urge the vessel into the correct, fluid-tight position.

Additionally or alternatively preferably, the system includes a locking ring, further preferably comprising two or more separable sections, the locking ring locatable about the vessel and having diametrically opposed notches in the outer portion of the ring.

Preferably, the system includes one or more sensors selected from a heat, smoke, carbon monoxide sensor.

The system preferably includes a data processor connected to receive data from a sensor and to process data received. The data processor is further optionally connected to an alarm or user-alert in the event the data received falls outside pre-determined values.

### BRIEF DESCRIPTION OF THE DRAWINGS

The invention is now described with reference to the accompanying drawings which show, by way of example only, an embodiment of a fire suppression system. In the drawings:

FIGS. 1a, 1b are respectively a perspective and an end view of a first embodiment of a support;

FIGS. 2a, 2b are respectively a top and an end view of a second embodiment of a support including fire-extinguishing devices in position;

FIG. 3a illustrate a side view of a vessel resting on a support bracket;

FIGS. 3b, 3c illustrate, respectively, a side view of a support bracket including a locking bracket and a perspective view of a locking bracket;

FIG. 3d illustrates a supported vessel locked in position;

FIG. 4 illustrates a layout of fluid pathways within a support;

FIG. 5 illustrates a compression means; and

FIGS. 6a-6c illustrate a locking means for the compression means of FIG. 5.

### DETAILED DESCRIPTION OF THE INVENTION

The particular fire suppression system described herein acts as follows. Upon the hazard area exceeding the predetermined heat threshold, a misting or sprinkler head is activated, thereby allowing the suppression agent, usually a water-based agent, to flow through directional channels of the misting head or sprinkler head, expelling fire suppression agent in 360 degrees. The misting unit is monitored via a low-pressure switch that can be attached to a notification light, alarm panel, or a notification-sending unit that can connect to an external mobile phone application or wireless panel.

Additionally or alternatively, the fire-extinguishing medium is contained within a flexible bag within a vessel which increases the usage of the fire-extinguishing medium.

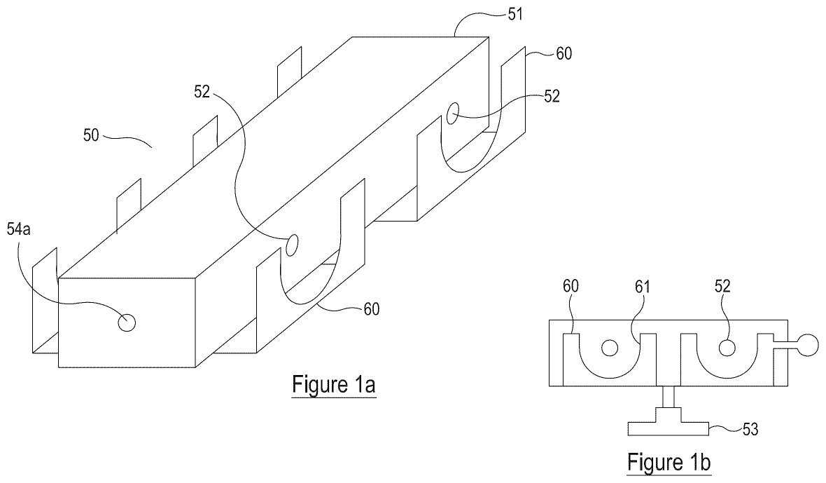

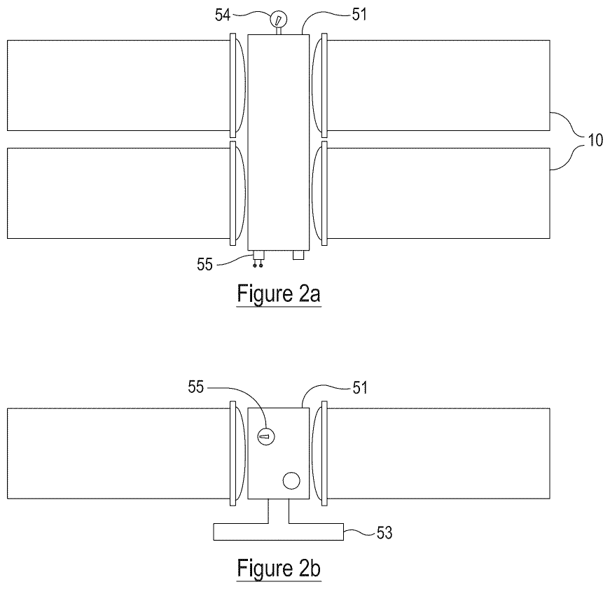

In order to increase the flexibility and capacity of a sprinkler system, a plurality of vessels can be utilised, housed in a common support for convenience. An example of a suitable housing is an adapter 51 as shown in FIGS. 1 and 2. The housing, generally referenced 50 comprises a multiport adapter 51. The housing 50 and adapter 51 can be mounted either in a ceiling void or mounted directly to the ceiling in a suitable housing. The shape of the housing 50 can be chosen to suit the space available for the housing 50 to be mounted. Moreover, for larger areas for example, two or more separate housings can be used in conjunction with each other to increase the volume of fluid deliverable and also the range of fluids.

The adapter 51 has a plurality of ports 52 into each of which a fire-extinguishing vessel can be secured. For example, a vessel can be secured to a port 52 by a push-fit, fluid-tight connection, of either a male or female type. Each port 52 is fluidly connected via a series of pipes, to a sprinkler head 53, which in a preferred embodiment is a misting sprinkler head. Other heads can alternatively be utilised such as a regular sprinkler head, aspirating head or other such device.

The connection preferably includes a one-way valve to prevent fluid from flowing in the wrong direction, for example being forced from a second vessel into a first vessel rather than being forced through the sprinkler head. Alternatively or additionally the one-way valve is included in a pipe. A pressure gauge 54 is connected into the pipes at port 54a, conveying the fire-extinguishing medium to monitor the pressure therein. A pressure switch 55 is additionally provided.

The use of a multiport system also enables a single sprinkler system to be used capable of acting on different types of fire as they may arise. For example, different fire-extinguishing media can be contained in different vessels attached to a multiport adapter. In the event therefore, say, of an electrical fire, the correct fire-extinguishing medium can be discharged. Moreover, the vessels attached to an adapter can be of different sizes to enable fires of different sizes to be dealt with appropriately.

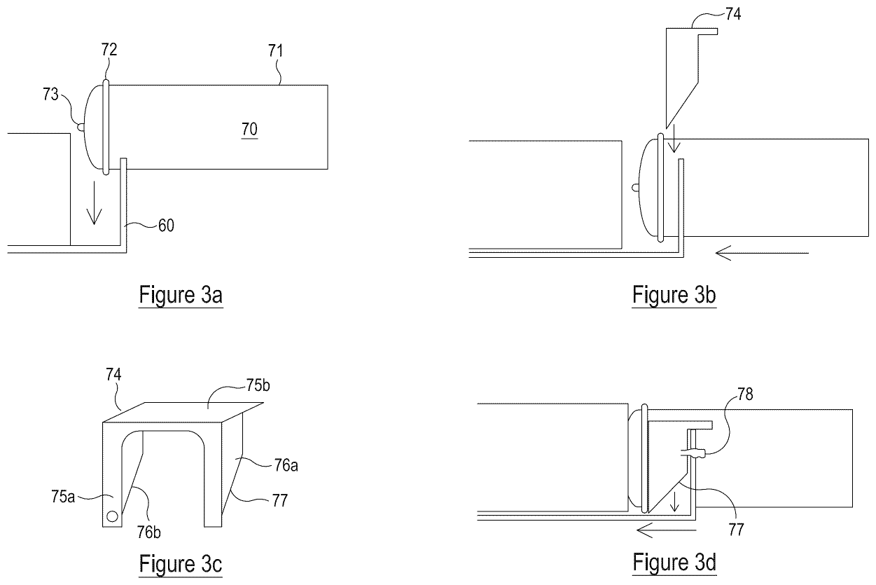

Each vessel 10 is supported by a bracket support 60, which includes a profiled section 61 in which the vessel 10 is housed. The bracket support 60 reduces the turning forces about the port 52 on a vessel 10 and so reduces the risk of the connection therebetween breaking or leaking fluid. Additional means such as lugs, to engage the vessel 10 can be included to further reduce the risk of the vessel 10 turning. The profiled section 61 can also include a coating or covering having a high coefficient of friction to grip the vessel 10. The vessel 10 can be further secured in position by means of a locking bracket as shown in FIGS. 3a-3d.

In FIG. 3a is shown a vessel 70 lowered into the profiled section 61 of a bracket support 60. The vessel 70 has a circumferential collar 72. The vessel 70 can be, for example, an aerosol type vessel actuated by depression of the nozzle 73. Once the vessel 70 is in position, a locking bracket 74 is pushed into position. A locking bracket 74 comprises two plates 75a, 75b at right-angles to each other. The plate 75a has a cut-out to receive the container body 71 of the vessel 70 as the locking bracket 74 is moved downwardly over the vessel 70 as shown in FIG. 3b. Guide plates 76a, 76b are provided having, in the illustrated embodiment, a trapezoidal shape, but with the lower edge 77 angled such that as the locking bracket 74 is pushed downwards the locking bracket 74 is also forced towards the adapter 51. As the locking bracket 74 moves towards the adapter 51, the plate 75a engages the collar 72 and urges the vessel 70 towards the adapter 51, eventually pushing the nozzle 73 into sealing engagement with the port 52. The nozzle 73 is thereby depressed, bringing the sprinkler head 53 into fluid communication with the contents of the vessel 70. A locking pin 78 can be utilised to secure the locking bracket in position.

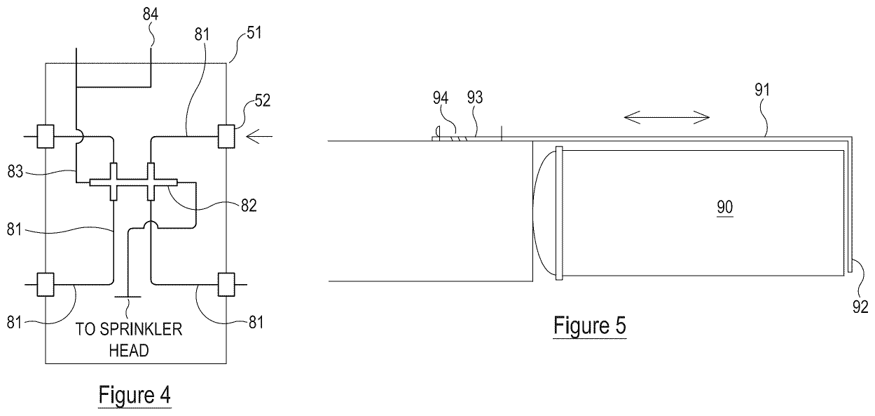

FIG. 4 illustrates a layout of fluid conduits within an adapter 51 as shown in the previous Figures. The fluid conduits provide a fluid linkage enabling the fire-extinguishing medium to travel from a vessel 10 to a sprinkler head 53. The ports 52 comprise a 5/32 compression fitting equipped with a one-way valve to prevent backflow of fire-extinguishing medium into the vessel 10. Each port 52 is linked via small bore pipes 81, which can be drilled or moulded connecting pipework, to a fitting 82, in this embodiment a 6-way fitting, sufficient to link, in this embodiment, all the ports 52 to the sprinkler head 53. In other embodiments, not illustrated, for example where vessels contain different fire-extinguishing media, a separate fluid pathway can be included for each of the different media.

An arm 83 of the pipes 81 links the fitting 82 to a pressure switch, optionally connected to a smart system. A branch 84 off the arm 83 connects a pressure gauge 54 to the pipes 81 to allow the monitoring of the pressure therein.

FIG. 5 illustrates a compression bracket 91, usable as an alternative means of maintaining a vessel 90 in position with reference to an adapter 51. The vessel 90 can be of the aerosol type shown in FIG. 3. The compression bracket 91 comprises an end-plate 92 which in use engages the base of the vessel 90. The end-plate 92 is mounted to the adapter 51 by a spring-loaded mount 93 having a tensioned spring 94. As the vessel 90 is positioned in the adapter 51, the end-plate 92 is pulled away from the adapter 51, putting the spring 94 in increased tension. When the pulling force is removed, the spring 94 acts to draw the end-plate 92 towards the adapter 51 which holds the vessel 90 in the correct position.

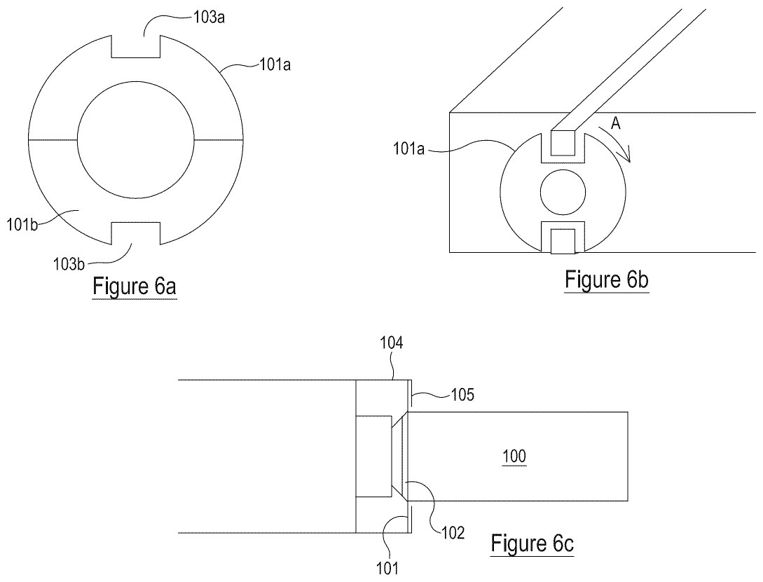

Alternatively or additionally to the compression bracket 91 described above, an alternative means of bringing and maintaining an aerosol vessel 100 in fluid engagement with the adapter 51 is shown in FIG. 6. A locking ring 101 is placed around the neck of the aerosol vessel 100. The locking ring 101 can, as shown in FIG. 6a comprise 2 pieces 101a, 101b, which are clipped or bolted together about an aerosol collar 102. The assembled locking ring 101 has two diametrically opposed notches 103a, 103b in the outside of the locking ring 101. The notches 103a, 103b allow the locking ring 101 to be pushed beyond a locking bracket 104, to be located beyond a limb 105 of the locking bracket 104. In moving the locking ring to this position, the nozzle of the aerosol vessel 100 is pushed into the port 52 and is depressed, bringing the fire-extinguishing medium within the aerosol vessel 100 into fluid engagement with the pipes 81. Once in position, the locking ring 101 is twisted as shown by the arrow A in FIG. 6b, which locks the aerosol vessel 100 in position.

Activation, is by means of ways known in the art. For example, the adapter can be linked to a conventional wall-mounted alarm activated by a user breaking a glass panel to push the alarm-button beneath. Alternatively, the sprinkler head can include heat, smoke, carbon monoxide etc. monitors, activation of which causes the appropriate vessel to be opened releasing the vessel's contents. In a further alternative the contents of a vessel can be released manually.

In addition, temperature sensors or thermostats can be provided in the monitored location which are linked either by a physical connection or wirelessly to the adapter. The location can for example be in a room of a building to provide general monitoring or close to an appliance such as a cooker.

Such sensors or thermostats monitor room temperature and can sense spikes in the temperature. Sufficient spikes in room temperature cause the sensor/thermostat to send a signal to a ceiling unit to activate. Connectivity to existing thermostats, smart thermostats, smart home systems is also possible. Activation by this means will require a solenoid or similar device and not require a glass break on the misting/sprinkler head. Glass-break activated sprinkler/misting head can be used where remote activation with sensors/thermostats is not in place.

The multiport adapter described above can include additional functionality to increase safety and also to reduce costs of installation and maintenance. For example, a monitor can be included to determine the pressure within a vessel, the monitor being linked to a warning light or external monitoring system in the event that the pressure drops below a pre-set level. Further, an adapter can be linked to a smart home system, alarm system or can send an alarm direct to the emergency services in order to raise an alert.

1. A fire suppression system, the system comprising a housing having one or more ports to receive a nozzle of a fire extinguisher, the fire extinguisher also including a container to house a fire-extinguishing fluid, the container being fluidly linked with the nozzle, actuation of the nozzle allowing fire-extinguishing fluid to exit the container via the nozzle, insertion of a nozzle into a port actuating the nozzle, the or each port being in fluid linkage with a distribution head by a pipe to distribute fire extinguishing fluid, the port and the distribution head being fluidly linked.

2. The fire suppression system according to claim 1, wherein the distribution head is selected from a misting sprinkler head, an aspirating head, regular sprinkler head.

3. The fire suppression system according to claim 1, wherein the port includes a connection to receive a nozzle.

4. The fire suppression system according to claim 1, wherein the pipe includes a one-way valve.

5. The fire suppression system according to claim 1, wherein the system includes a pressure gauge.

6. The fire suppression system according to claim 1, wherein the system includes a plurality of vessels.

7. The fire suppression system according to claim 6, wherein different vessels contain different fire-extinguishing fluids.

8. The fire suppression system according to claim 6, wherein a vessel is supported by a bracket support including a profiled section within which the vessel is seated.

9. The fire suppression system according to claim 8, wherein is coated or covered by a material having a high co-efficient of friction.

10. The fire suppression system according to claim 8, wherein the bracket supports includes means such as a lug to resist vessel rotation.

11. The fire suppression system according to claim 1, wherein the housing includes a compression bracket having an end-plate mounted to the housing by a spring-loaded mounted to urge the vessel into the correct, fluid-tight position.

12. The fire suppression system according to claim 1, wherein the system includes a locking ring.

13. The fire suppression system according to claim 12, wherein the locking ring comprises two or more separable sections, the locking ring locatable about the vessel and having diametrically opposed notches in the outer portion of the ring.

14. The fire suppression system according to claim 1, wherein the system includes one or more sensors selected from a heat, smoke, carbon monoxide sensor.

15. The fire suppression system according to claim 1, wherein the system includes a data processor connected to receive data from a sensor and to process data received.

16. The fire suppression system according to claim 15, wherein the data processor is further optionally connected to an alarm or user-alert.
